(19) United States
(12) Patent Application Publication
(10) Pub. No.: US 2010/0101027 A1
(43) Pub. Date: Apr. 29, 2010

(54) Innerspring Mattress System

(75) Inventor: George Giannopoulos, Oakleigh (AU)

Correspondence Address: Intellectual Property Law Office of David Lathrop, No. 827, 39120 Argonaut Way, Fremont, CA, 94538, US

(73) Assignee: Select-O-Pedic Bedding Pty Ltd, Moorabbin (AU)

(21) Appl. No.: 12/549,519

(22) Filed: Aug. 28, 2009

(30) Foreign Application Priority Data
Aug. 29, 2008 (AU) 2008 904467

(51) Int. Cl. A47C 23/04; A47C 23/053; B68G 7/00

(52) U.S. Cl. 5/716; 29/91.1

(57) ABSTRACT

There is disclosed a mattress comprising a first border member configured to define an upper periphery of the mattress and a second border member configured to define a lower periphery of the mattress. At least two spring assemblies are positioned within the first and second border members so as to extend between the first and second border members. Each spring assembly comprises an array of coil springs and each spring assembly is positioned such that the coil springs of one spring assembly are not directly connected with coil springs of any other spring assembly.

### FIELD OF INVENTION

The present invention relates generally to a mattress system for use in bedding, and in particular, to an innerspring coil system for a mattress.

### BACKGROUND ART

Innerspring mattresses are the most common mattresses sold today. Such mattresses typically comprise a layer or layers of coil springs arranged between the bed frame and the surface of the mattress, such that the coil springs act as a support structure of the mattress, providing stability and comfort to the user of the mattress.

A variety of different types of coil springs have been proposed. The most common type of coil spring being an open or Bonnell coil spring. Bonnell coil springs are comprised of wire formed in an hour glass spring shape, with each of the individual springs being joined to adjacent springs by way of small helically wound wires, called helicals. Thus, the helicals extend in a parallel arrangement with respect to the surface of the mattress, either in the longitudinal or width direction of the mattress, joining together the individual coil springs in a matrix of rows. Such a coil arrangement is relatively inexpensive to manufacture and provides a firm surface to the user. However, the coils may fatigue more quickly than other types of coils, resulting in the mattress losing its shape.

An alternative type of coil that operates in a similar manner to the Bonnell coil spring is an Offset coil. The Offset coil spring is constructed in a similar manner to the Bonnell coil spring but has a squared or levelled head and bottom to enable individual coils to easily fit together in a parallel fashion. Each of the individual coils are also laced together by helically wound connecting wires to prevent the coils from laterally moving when compressed under load. Such a design allows the mattress to better conform to the contour of the body and prevents leaning and sagging of the mattress.

However, mattresses of the above types still suffer from a number of disadvantages. As neighbouring springs are interconnected by the helicals, the helicals tend to lock neighbouring springs together rather firmly, resulting in the springs failing to be individually resilient. As a result, any load applied to one of the springs of the mattress will cause deflection not only of that spring but also of neighbouring springs. This detracts from the adaptability of the mattress and as the spring coils do not distribute the supporting force evenly across the user's entire body surface, the mattress is less comfortable. Further, such a mattress is less likely to provide motion separation across the surface of the mattress.

More recently, pocketed coil mattresses, also known as Marshall coil mattresses, have been proposed. These types of mattresses include a spring coil that is wrapped in a cloth cover or pocket and is sewn or glued together to form an individual unit. Each spring coil is typically wrapped such that they are under tension at all times. Each spring coil works independently, thus reducing the tendency of the individual spring coils to spread when compressed. As a result, Marshall coil mattresses are designed to give the most contour of any mattress support system. Such mattresses provide a particular advantage in the area of motion or partner disturbance as the pocket coils provide more motion separation than other innerspring arrangements. Hence, movement in one part of the mattress is typically not transferred, or transferred in a significantly less amount to other areas of the mattress. However, Marshall coil mattresses may not provide significant support over time for heavier people as the individual coils endure greater strain over time, since each coil endures weight without distributing such weight to other nearby coils. Further, mattresses having such a coil spring arrangement are also significantly more expensive due to their more detailed construction and manufacturing process.

Accordingly, it is desirable to provide a mattress having an innerspring coil design that is relatively simple and inexpensive to manufacture and which provides enhanced comfort and motion control to the user(s).

The above references to and descriptions of prior proposals or products are not intended to be, and are not to be construed as, statements or admissions of common general knowledge in the art. In particular, the following prior art discussion does not relate to what is commonly or well known by the person skilled in the art, but assists in the understanding of the inventive step of the present invention of which the identification of pertinent prior art proposals is but one part.

### STATEMENT OF INVENTION

Accordingly, in one aspect of the invention there is provided a mattress comprising:
a first border member extending about an upper periphery of the mattress;
a second border member extending about a lower periphery of the mattress;
at least two spring assemblies positionable within the first and second border members, each spring assembly being separated with respect to each other spring assembly.

In one embodiment, each spring assembly comprises an array of coil springs. In one form, the coil springs may be open or Bonnell type coil springs. In another form, the coil springs may be offset coil springs. In yet another form, the coil springs may be Marshall coil springs.

The array of coil springs may comprise a plurality of rows coil springs arranged in a plurality of columns. Each of the columns of coil springs may be interconnected by way of one or more helically wound connector wires extending substantially along a length of the column.

The first and second border members may be first and second wires shaped to define an upper and lower periphery of the mattress respectively. The first and second wires may be shaped to define a substantially quadrilateral shape. The substantially quadrilateral shape may be a rectangle or a square, namely the desired shape of the mattress.

Each spring assembly may be secured in position within the first and second border members. The spring assemblies may be secured in position by securing individual coil springs to the first and second border members at an upper and lower periphery thereof. The spring assemblies may be secured to the border members such that there is a separation gap or space formed therebetween.

A cover may be secured to the first and second border members so as to substantially cover an upper and lower surface of the at least two spring assemblies positioned therein. The cover may extend between the separation gap or space formed between the spring assemblies to be secured to an edge of the corresponding spring assembly.

According to another aspect of the present invention, there is provided a method of forming a mattress comprising:
forming a first border member to define an upper periphery of the mattress and a second border member to define a lower periphery of the mattress;
forming at least two spring assemblies comprising an array of interconnected coil springs;
positioning the at least two spring assemblies within the first and second border members such that the assemblies are separated from each other by a separation gap;
applying a cover across an under surface and an upper surface of the at least two spring assemblies such that the cover extends between the or each separation gap;
applying upholstery about the first and second border members and the at least two spring assemblies to form the mattress.

The step of forming the at least two spring assemblies may comprise interconnecting a plurality of coil springs in an array of rows and columns.

The step of positioning the at least two spring assemblies may comprise securing at least one of the coil springs of each spring assembly to the first and second border members at an upper and lower periphery thereof.

### BRIEF DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention. In the drawings:

FIG. 1 shows a plan view of a conventional innerspring mattress arrangement according to the prior art;

FIG. 2 shows a plan view of a first embodiment of an innerspring arrangement according to the present invention;

FIG. 3 shows a plan view of the innerspring arrangement of FIG. 2 during a manufacturing step according to an embodiment of the present invention;

FIG. 4 shows a sectional end view of the innerspring arrangement of FIG. 3;

FIG. 5 shows a plan view of an alternative embodiment of an innerspring mattress in accordance with the present invention; and

FIG. 6 is a flow diagram showing an embodiment of forming a mattress in accordance with the present invention.

### DETAILED DESCRIPTION OF THE DRAWINGS

The present invention will be described below in relation to the use of open or Bonnell coil springs. However, it will be appreciated that other types of coil springs, such as Offset coil springs and Marshall coil springs, may also be employed with the present invention and still fall within the spirit of the preset invention.

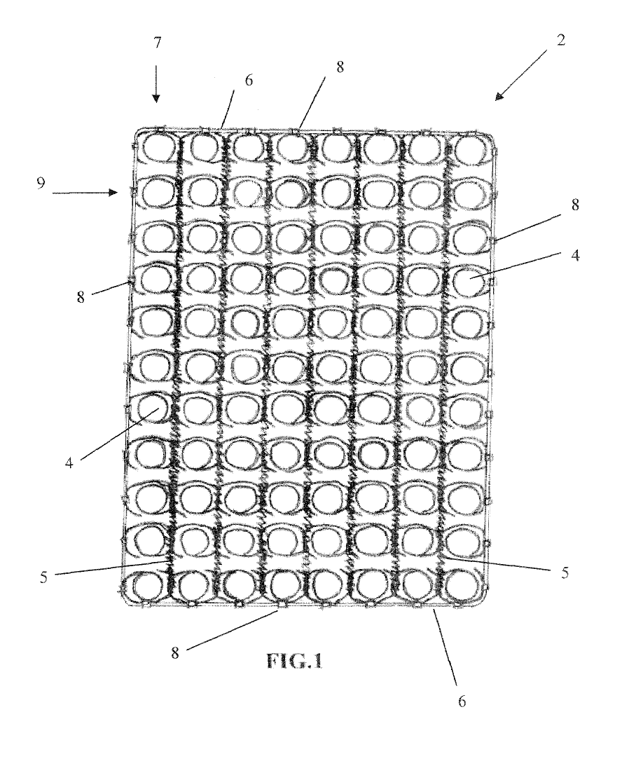

Referring to FIG. 1, a mattress structure 2 employing Bonnell coil springs of the prior art is shown. The mattress structure 2 comprises a plurality of individual coil springs 4 located within a border member 6. The border member 6 is typically in the form of two separate wires that define an upper and lower border of the mattress structure 2.

Coil springs 4 are arranged in an array within the border members 6. The array of coil springs 4 are arranged in a plurality of rows 9 extending across the width of the mattress structure 2 so as to form a plurality of columns 7 of coil springs 4 extending along the length of the structure 2. Adjacent columns 7 of coil springs 4 are connected along a common edge by helicals 5, in the form of one or more helically wound connecting wires. Each of the coil springs 4 located around the periphery of the structure 2 are each connected to the adjacent border member 6 at their upper and lower extremities by way of clips 8.

In this arrangement, the border members 6 support the coil springs 4 to provide shape and structural support for the mattress structure 2, thereby reducing any sagging of the completed mattress. The edge or sides of the mattress structure 2 are typically reinforced with foam, thereby preventing or substantially reducing the likelihood of roll-out or edge breakdown of the mattress. To finish the mattress, the structure 2 is typically covered with an insulating layer or layers of padding such that the padding extends across the upper and lower surfaces of the structure 2. Upholstery may then be applied to the structure 2 to finalise the mattress. The upholstery is separated from the structure 2, by way of the insulating layer of padding, to prevent the upholstery from sinking into the coils 4 during use.

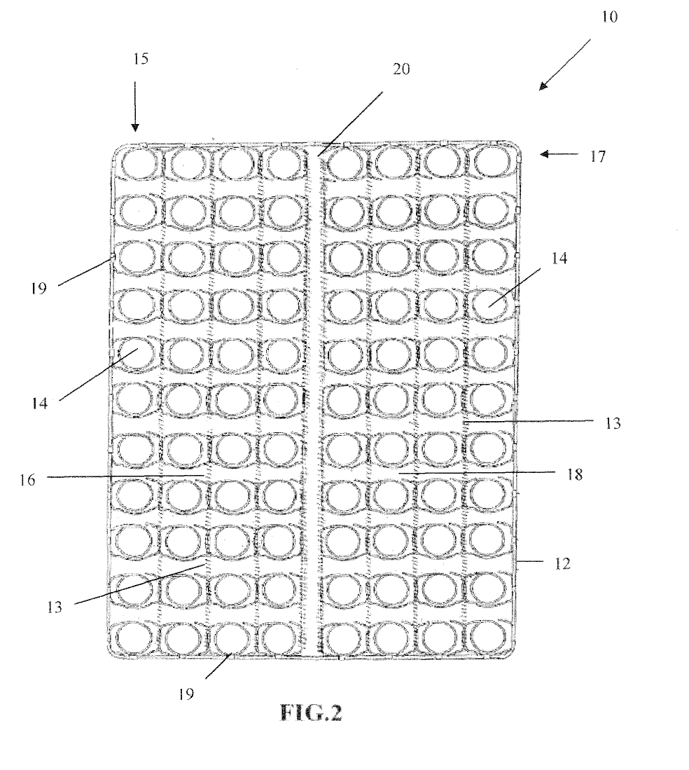

Referring to FIG. 2, a mattress structure 10 according to one embodiment of the present invention is shown. The mattress structure 10 also comprises a plurality of coil springs 14 arranged within and extending between upper and lower border members 12.

In the embodiment as shown in FIG. 2, the coil springs 14 are arranged into a first assembly 16 and a second assembly 18. The first assembly 16 and second assembly 18 each comprise an array of coil springs 14 arranged in four columns 15 of eleven rows 17. The columns 15 of coil springs 14 are shown extending in a parallel arrangement along the length of the structure 10, whilst the rows 17 extend orthogonally with respect to the columns 15, at least partially across the width of the structure 10. However, it will be appreciated that the total number of columns and rows of coil springs 14 and their orientation within each assembly may vary in accordance with the requirements of the mattress and still fall within the spirit of the present invention. Similarly, the first assembly 16 and the second assembly 18 may have differing numbers of columns and rows of springs 14 and still fall within the spirit of the preset invention.

Each of the first and second assemblies 16, 18 are arranged within and between the upper and lower border members 12 such that a gap 20 is formed therebetween. In the embodiment as shown, the gap 20 extends longitudinally along the centre of the structure 10 such that the assemblies 16 and 18 are separated by this gap.

As is shown in FIG. 2, each of the coil springs 14 of the first and second assemblies 16, 18 that are positioned adjacent the upper and lower border members 12 are secured at their upper and lower ends to the border members 12 by way of clips 19. Such an arrangement ensures that the first and second assemblies 16, 18 are securely retained in position within the structure 10. Adjacent columns 15 of springs 14 of each assembly 16, 18 are connected along a common edge by helicals 13, in the form of helically wound connector wires. Helicals 13 are typically provided on both the upper and lower surfaces of the structure 10.

As each of the first and second assemblies 16, 18 are separated by gap 20, the assemblies 16, 18 define two separate regions of the mattress structure 10. As such, the coil springs 14 of the first assembly 16 move substantially independently of any load that may be applied to the coil springs 14 of the second assembly 18. This greatly reduces any transfer of movement between the assemblies 16 and 18 of the structure 10, thereby resulting in a mattress with reduced motion or partner disturbance.

As the first and second assembly 16, 18 are each retained within the border members 12 of the structure 10, the border members 12 still function to provide shape and structure to the mattress, preventing roll-out and edge breakdown of the mattress. However, whilst the assemblies are connected along the border members 12, there is substantially negligible transfer of motion between the assemblies 16, 18 along the border members 12. As such, a mattress having an innerspring structure 10 does not function as two independent mattresses having distinct borders, but rather a single mattress having independent portions or regions formed therein.

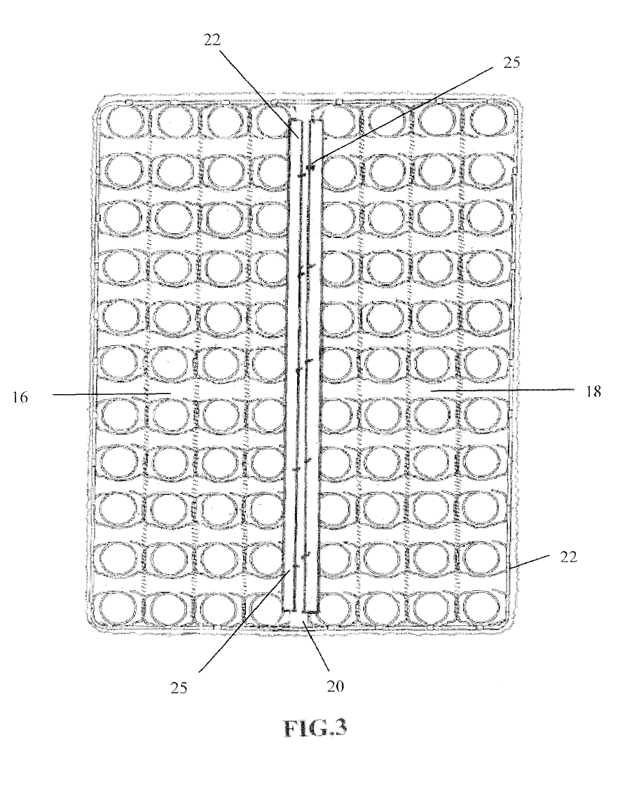

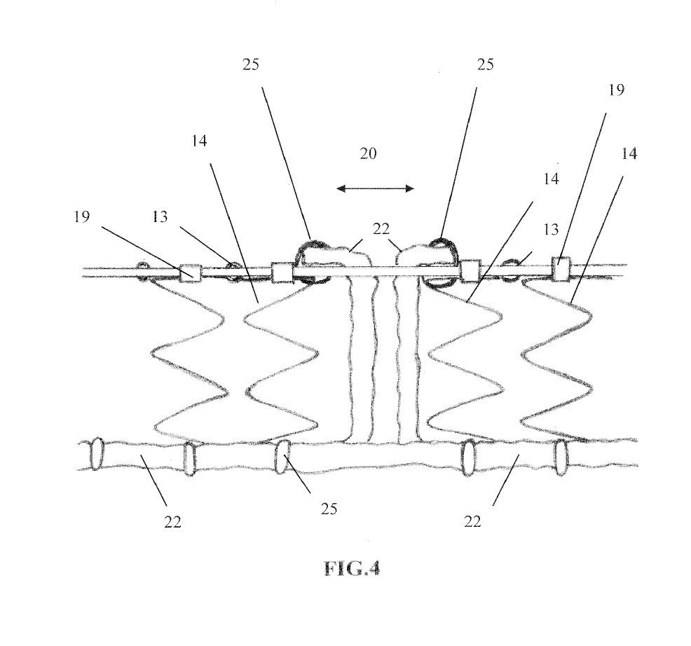

Following formation of the structure 10 as shown in FIG. 2, the structure 10 may be covered in the manner as shown in FIGS. 3 and 4. Such covering of the structure 10 is typically applied prior to applying the upholstery to complete the mattress.

The cover 22 is in the form of an insulating matting or layer that is firstly applied to an under surface of the structure 10 by crimping or clipping the cover 22 to the border member 12 at regular intervals around the periphery thereof by way of staples 25. This ensures that the under surface of the structure 10 and the open coil springs 14, are covered by the cover 22.

As is shown in FIGS. 3 and 4, the cover 22 extends from the under surface of the structure 10 through the gap 20 to the upper surface of the structure. The cover 22 is then crimped or pinned by staples 25 to each of the first and second assemblies 16, 18 along the gap 20.

By passing the cover 22 between the gap 20 and securing the cover 22 to the corresponding first and second assemblies 16, 18, each of the assemblies are further separated and isolated.

It will be appreciated that to complete the covering of the mattress a second cover, similar to cover 22 will be applied across the upper surface of the structure 10 so as to be clipped or crimped about the upper border member 12. Such an arrangement of covers 22 will enable upholstery to be applied to the structure 10 such that the upholstery will be prevented from sinking into the springs 14.

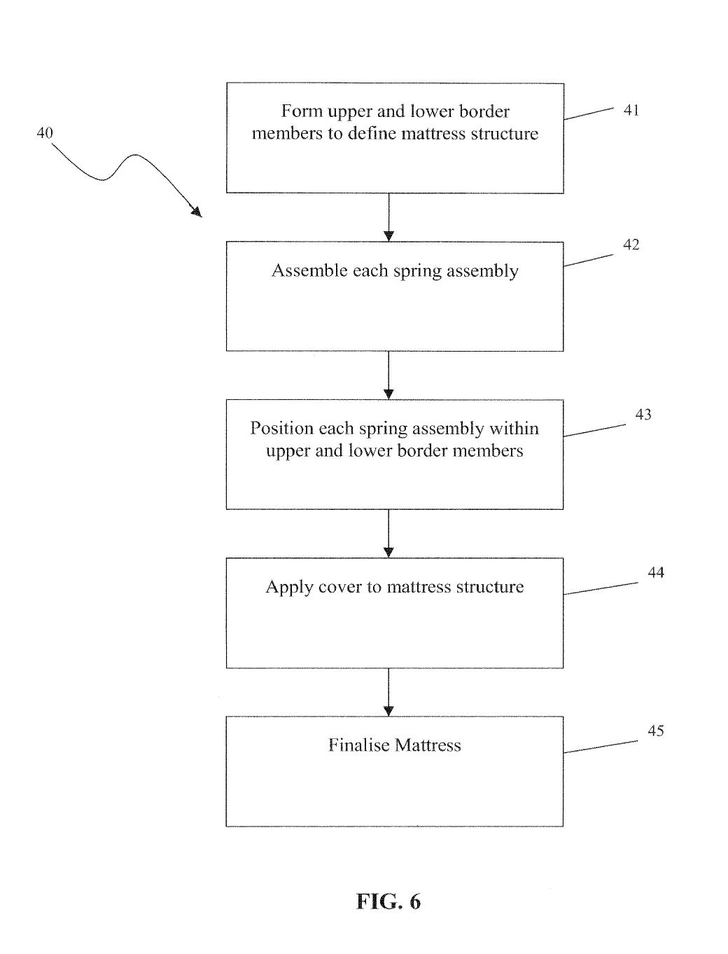

A preferred method 40 of forming the mattress according to the present invention is shown in FIG. 6.

The method 40 comprises a first step 41 wherein the first and second border members 12 are formed to define the structure of the mattress. The first and second border members 12 define an upper and lower periphery of the mattress to be formed, in the manner as discussed above.

In step 42, the spring assemblies 16, 18 are assembled according to the requirements of the mattress with individual coil springs 14 arranged into assemblies comprising rows and columns. Neighbouring columns of coil springs are connected at opposing ends along a common edge by way of helicals 13.

In step 43, the spring assemblies 16, 18 are positioned within the first and second border members 12 and secured thereto in the manner as described above.

In step 44, a cover is applied to the mattress structure in the manner as described above, after which the final upholstery is applied in step 45 to complete the mattress.

It will be appreciated that the steps 41-45 may be performed in a variety of orders and still fall within the spirit of the present invention.

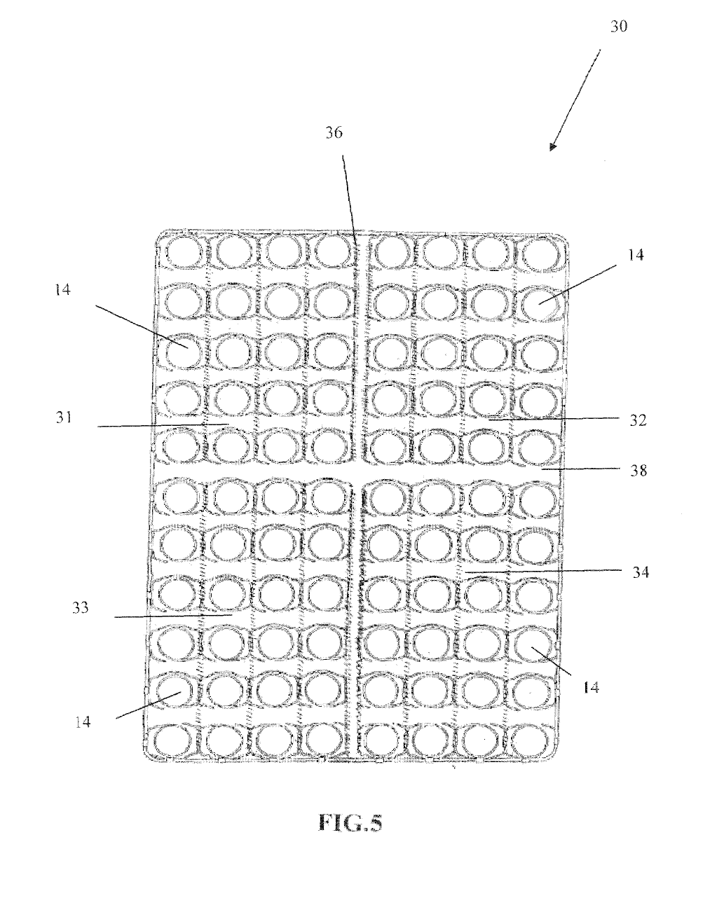

Referring to FIG. 5, an alternative embodiment of a mattress structure 30 of the present invention is shown. In this embodiment the structure 30 comprises four separate spring assemblies 31, 32, 33, 34 comprising an array of spring coils 14. Each of the assemblies 31-34 are separated by way of a longitudinally extending gap 36 and a laterally extending gap 38 to define four distinct and separate regions of the mattress structure 10. It will be appreciated that the total number of spring assemblies provided within the structure 30 may vary and still fall within the spirit of the present invention.

It will be appreciated that a mattress employing the coil spring structure as described above in accordance with the present invention, provides a mattress that is relatively simple and inexpensive to manufacture and which provides enhanced comfort and motion control to the user(s). Due to the mattress structure having a plurality of separate spring assemblies within the overall structure of the mattress, there is reduced motion transfer between spring assemblies whilst providing desired firmness and support to the user.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the mattress uppermost.

It will be appreciated by those skilled in the art that many modifications and variations may be made to the methods of the invention described herein without departing from the spirit and scope of the invention.

1. A mattress comprising:
a first border member configured to define an upper periphery of the mattress;
a second border member configured to define a lower periphery of the mattress; and
at least two spring assemblies positionable within the first and second border members so as to extend between the first and second border members;
wherein each spring assembly comprises an array of coil springs and each spring assembly is positioned such that the coil springs of one spring assembly are not directly connected with coil springs of any other spring assembly.

2. A mattress according to claim 1, wherein the coil springs are open or Bonnell type coil springs.

3. A mattress according to claim 1, wherein the coil springs are offset coil springs.

4. A mattress according to claim 1, wherein the coil springs are Marshall coil springs.

5. A mattress according to claim 1, wherein the array of coil springs comprises a plurality of rows of coil springs arranged in a plurality of columns.

6. A mattress according to claim 5, wherein each column of coil springs is connected along a length of the column.

7. A mattress according to claim 6, wherein each column of coil springs is connected by way of one or more helically wound connector wires extending substantially along the length of the column.

8. A mattress according to claim 7, wherein the first and second border members are first and second wires shaped to define an upper and lower periphery of the mattress respectively.

9. A mattress according to claim 1, wherein each spring assembly is secured in position within the first and second border members by securing selected individual coil springs to the first and second border members at an upper and lower periphery thereof.

10. A mattress according to claim 9, wherein each spring assembly is secured to the first and second border members such that there is a separation gap or space formed between each spring assembly.

11. A method of forming a mattress comprising:
providing a first border member to define an upper periphery of the mattress and a second border member to define a lower periphery of the mattress;
forming at least two spring assemblies, each spring assembly comprising an array of coil springs;
positioning the at least two spring assemblies within the first and second border members such that the coil springs of each assembly are separated from each other by a separation gap;
applying a cover across an under surface and an upper surface of the at least two spring assemblies such that the cover extends between the or each separation gap; and
applying upholstery about the first and second border members and the at least two spring assemblies to form the mattress.

12. A method according to claim 11, wherein the step of providing a first border member and a second border member comprises shaping a first and second wire to form the first border member and the second border member.

13. A method according to claim 11, wherein the step of forming the at least two spring assemblies comprises arranging a plurality of coil springs in an array of rows and columns.

14. A method according to claim 13, wherein the step of forming the at least two spring assemblies comprises, for each spring assembly, connecting each column of coil springs to a neighbouring column by way of one or more helically wound connector wires extending substantially along a length of the columns

15. A method according to claim 11, wherein the step of positioning the at least two spring assemblies comprises securing at least one of the coil springs of each spring assembly to the first and second border members at an upper and lower end thereof.

16. A method according to claim 15, wherein the step of applying a cover comprises securing said cover to the first and second border members so as to substantially cover the under surface and the upper surface of the at least two spring assemblies positioned therein.

17. A method according to claim 16, wherein the cover extends between the separation gap formed between the spring assemblies.
